(19) United States
(12) Patent Application Publication
(10) Pub. No.: US 2024/0351915 A1
(43) Pub. Date: Oct. 24, 2024

(54) METHOD FOR PRODUCING FRESH WATER FROM AQUEOUS SALT SOLUTIONS

(71) Applicant: ECOSTAR-NAUTECH CO., LTD, Novosibirsk (RU)

(72) Inventors: Aleksandr Dmitriyevich RIABTSEV, Novosibirsk (RU); Valeriy Ivanovich TITARENKO, Novosibirsk (RU); Aleksandr Mikhailovich KOCHNEV, Moscow (RU); Nikolay Mikhaylovich NEMKOV, Novosibirsk (RU)

(73) Assignee: ECOSTAR-NAUTECH CO., LTD, Novosibirsk (RU)

(21) Appl. No.: 18/684,701

(22) PCT Filed: Aug. 23, 2022
(86) PCT No.: PCT/RU2022/050260

§ 371 Date: Feb. 19, 2024

(30) Foreign Application Priority Data
Sep. 6, 2021 (RU) 2021126108

(51) Int. Cl. C02F 1/14; B01D 5/00; C01D 15/04; C02F 101/12; C02F 103/10

(52) U.S. Cl. CPC C02F 1/14; B01D 5/006; C01D 15/04; C02F 2101/12; C02F 2103/10; C02F 2201/002

(57) ABSTRACT

A method and an apparatus for producing fresh water from aqueous salt solutions in the form of water vapor condensate released by cooling an air stream maximally saturated with water vapor and circulating between a condenser refrigerator and a device for heating, by solar rays, and contacting streams of the salt solution being dehydrated and of atmospheric air being saturated by the water vapor are provided. The initial lithium-bearing natural brine is used as a coolant prior to the use thereof as a raw lithium-bearing source for selective extraction of lithium on granulated LiCl·2Al(OH)₃·mH₂O sorbent. The method and apparatus allow the production of fresh water both from highly mineralized aqueous salt solutions and from low-mineralized solutions, for example, the fresh water extracted from natural primary lithium concentrate, without the costs associated with technogenic thermal energy provided by heating steam or electricity.

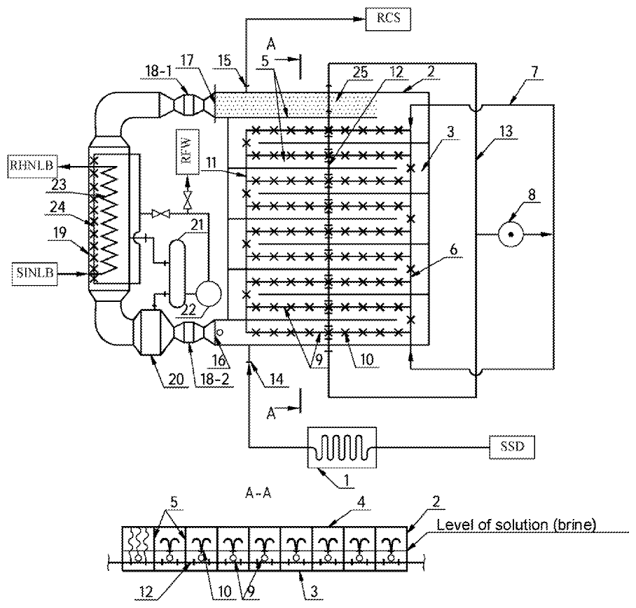

### CROSS REFERENCE TO THE RELATED APPLICATIONS

This application is the national phase entry of International Application No. PCT/RU2022/050260, filed on Aug. 23, 2022, which is based upon and claims priority to Russian Patent Application No. 2021126108, filed on Sep. 6, 2021, the entire contents of which are incorporated herein by reference.

### TECHNICAL FIELD

The present invention relates to the production of lithium products from a lithium-bearing hydromineral raw material and can be used to produce commercial lithium products from natural multicomponent lithium-bearing brines at facilities located in territories with high solar activity and arid climate and experiencing a deficiency or total absence of natural sources of fresh water.

### BACKGROUND

Lithium salts are obtained worldwide from both solid mineral lithium-bearing ores (spodumenes, lepidolite, petalite) and hydromineral lithium-bearing raw materials (lake brines, salar brines, deep underground formation brines, associated production brines from oil and gas production facilities, mineralized waters). The share of the facilities utilizing hydromineral raw material resources for the production of lithium products is steadily growing due to the lower cost of products obtained from hydromineral lithium-bearing raw sources.

All existing technologies for the production of lithium compounds from lithium-bearing hydromineral raw materials is predominantly focused on processing of lithium-bearing natural brines, the processing comprising obtaining therefrom pregnant lithium concentrates in the form of concentrated solutions of lithium salts, predominantly lithium chloride, which are suitable for production of commercial lithium products in the form of Li₂CO₃, LiCl·H₂O, LiOH·H₂O. At the same time, a significant number of explored deposits of lithium-bearing natural brines are located in desert geographical zones characterized, generally, by high solar activity, low atmospheric pressure and shortage of fresh water, i.e., in arid climate zones. The arid climate has predetermined the development of halurgic technologies for production of a pregnant lithium concentrate, which include stepwise solar concentrating of initial natural lithium-bearing brines with sequential salting out of macrocomponents and concentrating of lithium [1, 2]. The purification of the produced lithium concentrate from calcium, magnesium and sulphate-ion impurities is carried out in basins by adding calcium oxide, precipitating CaSO₄ and Mg(OH)₂ [3]. After purification from impurities, lithium chloride is obtained from the lithium concentrate by evaporation and dehydration, or lithium carbonate is obtained by soda deposition.

On the same basis, document [4] proposed a method for producing LiOH·H₂O from lithium-bearing brine, the method comprising obtaining, from a natural brine, a pregnant lithium concentrate in the form of a concentrated LiCl solution, converting it into a LiOH solution by membrane electrolysis, and evaporation of the LiOH solution until LiOH·H₂O crystallizes.

However, the inevitable evaporation of gigantic amounts of water into the atmospheric air with little or no fresh water available at the facility and generating large amounts of solid waste leading to environmental pollution and climate change in the regions are significant disadvantages of all methods for producing a pregnant lithium concentrate from natural lithium-bearing brines. Another disadvantage typical for all such methods is the limited hydromineral raw material base suitable for implementation of the methods. The halurgic technology was proven acceptable only for processing lithium-bearing brines of a sodium chloride type with low magnesium and calcium content.

A method for producing a pregnant lithium concentrate from natural lithium-bearing brines proposed by the Chinese experts [5] eliminates some of the disadvantages of the above methods, significantly reducing the amount of solid waste and eliminating the need for evaporating water into the atmospheric air. The method is based on dilution of the initial brine with fresh water to reduce mineralization, which allows separating lithium from magnesium sulphate by ultrafiltration after filtration purification from mechanical impurities. In turn, the lithium-enriched stream is re-diluted and subjected to nanofiltration for more complete removal of magnesium, calcium and sulphate-ions. The lithium-enriched stream (nanofiltration permeate) is directed to stepwise reverse osmosis concentration. The reverse osmosis concentration permeate (demineralized stream) is directed to dilution of the filtrate from ultrafiltration operation, and the lithium-enriched reverse osmosis concentrate (lithium content of 7-8 g/dm3) is directed to electrodialysis concentration, producing a dialysate, which is returned to the reverse osmosis concentration, and an electrodialysis lithium concentrate (lithium content of 28-29 g/dm3), which, after deep purification from impurities, represents a pregnant lithium concentrate. However, only natural brines of a sulphate type with total mineralization of no more than 200 g/dm³ and Li/(Mg+Ca) weight ratio of no more than 70 can be processed into a pregnant lithium concentrate using this method. Another significant disadvantage of this method is the required use of large quantities of fresh water which is scarce in such locations.

Methods for producing pregnant lithium concentrates from natural lithium-bearing brines, which are based on a selective sorption reagent-free separation of lithium from the initial lithium-bearing brine in the form of a LiCl aqueous solution (primary lithium concentrate) using granulated LiCl·2Al(OH)₃·mH₂O sorbent [6, 7], allow using, as a raw material, lithium-bearing natural multicomponent brines of any type with any Li/(Mg+Ca) weight ratio and to reduce significantly fresh water consumption due to its return to the production process at the step of processing primary lithium concentrate.

According to the method disclosed in [6], the initial natural brine is brought into contact in a sorption-desorption module consisting of several sorption-desorption columns with granulated LiCl·2Al(OH)₃·mH₂O sorbent, the module selectively sorbing LiCl from the natural brine while becoming saturated. After the saturation, the granulated sorbent undergoes stepwise brine removal using portions of a washing liquid, wherein the last portion is a portion of fresh water. LiCl is further desorbed from the granulated sorbent freed from the brine by bringing it into contact with a set volume of fresh water, producing a primary lithium concentrate in the form of an aqueous solution of lithium chloride containing residual brine macrocomponents as impurities. The primary lithium concentrate is further processed by concentration and purification into a pregnant lithium concentrate, from which the commercial lithium products being Li₂CO₃ and LiCl are obtained. The production process is established so that 93 to 95% of the fresh water is returned to the circulation as a reverse osmosis permeate formed during reverse osmosis concentration and as a secondary vapor condensate received from the operation of concentration by evaporation.

In terms of its technical essence and achieved effect, this method is the closest to the present invention and is selected by the inventors as the closest prior art for the present invention. However, along with the doubtless advantages, the prior art method has the following disadvantages. Firstly, despite the high performance of the prior art in terms of utilizing recycled fresh water, the need for fresh water consumed for washing the granulated sorbent from brine and provided from external sources remains, which is a serious obstacle in implementation of the method at deposit locations lacking real sources of fresh water supply. Another serious disadvantage of the prior art method consists in that the technological conversion processing of the primary lithium concentrate into a pregnant lithium concentrate and a water vapor condensate (fresh water) consumes a lot of energy due to the use of a superheated vapor as an energy carrier when implementing the thermal techniques for evaporation of aqueous solutions, accompanied by secondary vapor condensation, which conflicts with practical capabilities of the facilities located in areas with a pronounced arid climate for using solar energy instead of technogenic thermal energy for concentrating solutions and producing fresh water condensate.

The present method for producing fresh water from aqueous salt solutions from lithium-bearing natural brines at lithium production facilities in the conditions of high solar activity and arid climate retains all advantages of the prior art and eliminates the main disadvantages thereof, i.e. the present method allows eliminating completely fresh water consumption from external sources and, simultaneously, reducing significantly the energy consumption for the production of lithium products.

### SUMMARY OF THE INVENTION

The technical effect for eliminating the above disadvantages is achieved by the disclosed method for producing fresh water from an aqueous salt solution at a lithium production facility from a natural lithium-bearing brine in the conditions of high solar activity and arid climate, wherein a water vapor condensate is obtained by cooling a stream of forcibly moved atmospheric air saturated with water vapor, the air being previously heated and saturated with water vapor during its movement and straight flow contact with a forcibly moved stream of initial aqueous salt solution being heated in isolation from the environment, accompanied by maximum saturation of the atmospheric air stream with water vapor extracted from the aqueous salt solution and by concentration of the aqueous salt stream, wherein the produced stream of aqueous salt concentrate is removed from the process, and the stream of atmospheric air having passed the stage of water vapor cooling and condensation is again directed for contacting and joint heating with a fresh stream of initial aqueous salt solution, thus forming a closed circuit with a circulating stream of the atmospheric air and the flowing movement of the salt solution stream being concentrated.

The technical effect is achieved by heating the atmospheric air stream and the aqueous salt solution stream moving in a straight flow and contacting each other in isolation from the environment by means of solar energy transmitted to the streams being heated in the device directly by solar rays through a layer of a material permeable to solar rays and impermeable to atmospheric air and aqueous media.

The technical effect is achieved by pre-heating, by means of solar rays, the solution stream supplied for dehydration and concentration of the solution stream during transportation thereof through a heating element of a heater unit, wherein an outer surface of the heating element is painted black.

The technical effect is achieved by continuous forcible dispersing the salt solution during its movement, solar heating, contact with atmospheric air stream, and concentration.

The technical effect is achieved by a countercurrent movement of the pre-heated aqueous salt stream, during its dehydration and concentration, towards the movement direction of the air stream.

The technical effect is achieved by using a natural multicomponent lithium-bearing brine as the aqueous salt solution.

The technical effect is achieved by using, as the aqueous salt solution, a mother brine formed after sorption extraction of lithium from a natural multicomponent lithium-bearing brine on selective granulated LiCl·2Al(OH)₃·mH₂O sorbent.

The technical effect is achieved by using, as the aqueous salt solution, a primary lithium concentrate in the form of an aqueous solution of lithium chloride with impurities in the form of brine macrocomponents, the concentrate being formed by desorption extraction of lithium chloride, using fresh water, from lithium-saturated granulated LiCl·2Al(OH)₃·mH₂O sorbent during its direct contact with a natural multicomponent lithium-bearing brine.

The technical effect is achieved by using a natural multicomponent lithium-bearing brine as a coolant for cooling the heated atmospheric air saturated with water vapor.

The technical effect is achieved by using, as the aqueous salt solution, a catholyte in the form of an aqueous solution of lithium hydroxide produced by means of membrane electrolysis of a pregnant lithium chloride solution obtained from a primary lithium concentrate extracted from a natural multicomponent lithium-bearing brine using granulated LiCl·2Al(OH)₃·mH₂O sorbent and fresh water.

The technical effect is achieved by developing an apparatus for implementing the disclosed method for production of fresh water from an aqueous salt solution at a lithium production facility from a lithium-bearing natural brine in the conditions of high solar activity and arid climate, the apparatus comprising a heating unit for pre-heating, by solar rays, the aqueous salt solution supplied for dehydration and concentration, a device for dehydration and concentration of the aqueous salt solution by means of solar energy, the device comprising: a sealed housing comprising a blackbody bottom impermeable to the solution; a barrier impermeable to gases and liquids and permeable to solar rays; sealing partitions forming labyrinth galleries providing free movement of the aqueous salt solution being dehydrated within the device along the bottom and of air above the aqueous salt solution being dehydrated along a set path with a set path length; a discharge header for circulating the solution, the header connected at its ends to the exhaust of the circulation pump by means of pipelines and connected by its side surface through a branch pipe to a pipeline provided with a spraying member and mounted along the labyrinth galleries in the center of each labyrinth gallery and connected by their opposite ends to a header pipeline forming a closed spray circuit; a suction header providing circulation of the solution through the spray circuit and representing a perforated tube crossing the device along the center perpendicular to the labyrinth galleries below the level of the pipelines of the spray circuit and connected to the suction of the circulation pump at its ends by means of pipelines, a drop catcher in the form of a chain curtain, the catcher being arranged in the labyrinth gallery which is the last along gas stream path; a branch pipe for feeding the solution being dehydrated into the device and outputting a concentrated solution stream out of the device, openings for feeding the air stream into an initial labyrinth gallery of the device for heating and saturating with water vapor and outputting the heated and saturated air stream from a final labyrinth gallery of the device, a fan unit for circulating the air stream through the labyrinth galleries of the device, a condenser refrigerator for cooling the heated air stream saturated with water vapor and heating an initial natural lithium-bearing brine, a mist eliminator for the water vapor condensate dispersed within the air stream, a water vapor condensate collector, a pump for spraying (irrigating) the condenser refrigerator coil and outputting a produced fresh water in the form of water vapor condensate, a source of the aqueous salt solution being dehydrated, a receptacle for the dehydrated salt solution, a source of the initial natural brine, and a receptacle for fresh water.

The technical effect is achieved by connecting the output opening of the final labyrinth gallery of the device for dehydration and concentration of the solution with a suction branch pipe of the fan unit by means of a gas duct, wherein the fan unit is connected at its exhaust branch pipe with an inlet gas branch pipe of the condenser refrigerator by means of a gas duct, wherein the condenser refrigerator is connected at its outlet gas branch pipe to an inlet branch pipe of the mist eliminator by means of a gas duct, wherein the mist eliminator is connected at its outlet gas branch pipe to the suction branch pipe of the fan unit connected at its exhaust branch pipe to a feeding opening of the initial gallery of the device by means of a gas duct.

The technical effect is achieved by connecting the inlet branch pipe of the condenser refrigerator coil with the source of the initial natural brine by means of a pipeline, and connecting the outlet branch pipe of the condenser refrigerator coil with a receptacle for the heated initial natural brine, wherein the spray header of the condenser refrigerator coil is connected at its ends to the outlet branch pipe of the pump for spraying the condenser refrigerator coil and outputting the produced fresh water by means of a pipeline through a control valve, wherein the pump is further connected to the receptacle for fresh water by means of a pipeline through a control valve, and the suction branch pipe of the pump is directly connected via a pipeline to the fresh water collector collecting water in the form of water vapor condensate; wherein the fresh water collector collecting water in the form of water vapor condensate is connected, in turn, via a pipeline to the condensate drain branch pipe of the condenser refrigerator and to the condensate drain branch pipe of the mist eliminator.

The technical effect is achieved by connecting a branch pipe for feeding the aqueous salt solution being dehydrated and concentrated to a source of the solution to be dehydrated and concentrated via a pipeline through a heater unit for pre-heating, by solar rays, the aqueous salt solution supplied for dehydration and concentration and by connecting a branch pipe for outputting the concentrated salt solution from the device for dehydration and concentration of the aqueous salt solution to a receptacle for the concentrated salt solution via a pipeline.

The advantages of the disclosed solutions include:
eliminating the need to use fresh water supplied from external water supply sources;
using solar energy instead of heating steam energy when concentrating solutions by evaporation;
increasing the dynamic capacity and specific efficiency of the granulated sorbent for lithium due to the use, in selective sorption of lithium, instead of an initial cold natural lithium-bearing brine, of a natural lithium-bearing brine heated using thermal energy released from the air stream by water vapor condensation during production of fresh water from aqueous salt solutions (brines);
allowing to additionally produce (if necessary) fresh water by dehydration of the initial natural lithium-bearing brine.

The implementation of the present invention at the facilities located in regions exhibiting increased solar activity will allow producing high-quality commercial lithium products while significantly reducing production costs in the absence of sources of natural fresh water.

The information confirming the possibility of implementing the present invention is presented in the drawing and the accompanying description, as well as in the form of a specific example.

### BRIEF DESCRIPTION OF THE DRAWINGS

The FIGURE is a block diagram of the units of the apparatus for implementing the disclosed method for producing fresh water from aqueous salt solutions at facilities for producing lithium products from natural lithium-bearing brines in the conditions of high solar activity and arid climate.

### DETAILED DESCRIPTION OF THE EMBODIMENTS

### LIST OF REFERENCE CHARACTERS USED IN THE FIGURE

1. Heater unit for pre-heating, by means of solar rays, the aqueous salt solution supplied for dehydration and concentration;
2. Sealed housing of the device for dehydration and concentration of the solution (brine);
3. Blackbody bottom impermeable to solutions (brines);
4. Barrier impermeable to gases and permeable to solar rays;
5. Sealing partitions forming labyrinth galleries providing movement of the solution and air within the device along set paths and with a set path length;
6. Discharge header for circulating the solution;
7. Pipeline connecting the discharge header to the exhaust of the circulation pump;
8. Circulation pump;
9. Pipelines mounted along the labyrinth galleries in the center of each gallery;
10. Spraying members of pipelines mounted along the labyrinth galleries;
11. Header pipeline connected to the opposite ends of pipelines mounted along the labyrinth galleries;
12. Suction header for circulating the solution through the spray circuit;
13. Pipeline connecting the suction header of the spray circuit with the suction of the circulation pump;
14. Branch pipe for introducing the solution to be dehydrated into the device;
15. Branch pipe for outputting the concentrated (dehydrated) solution from the device;
16. Opening for feeding the air stream into the initial labyrinth gallery of the device;
17. Opening for outputting the air stream from the final labyrinth gallery of the device;
18-1, 18-2 Fan unit for providing air stream circulation through the labyrinth galleries of the device;
19. Condenser refrigerator for condensing water vapor from the circulating air stream and vapor formed by heating the initial natural brine;
20. Mist eliminator for the moisture dispersed into the air stream;
21. Fresh water collector collecting water vapor condensate;
22. Pump for spraying the condenser refrigerator coil and outputting the produced fresh water (condensate) into the receptacle for fresh water;
23. Condenser refrigerator coil;
24. Spray header for the condenser refrigerator coil;
25. Drop catcher formed by a chain curtain;
RFW—receptacle for fresh water;
SINLB—source of initial natural lithium-bearing brine;
RHNLB—receptacle for heated initial natural lithium-bearing brine;
SSD—source of aqueous salt solution to be dehydrated (concentrated);
RCS—receptacle for dehydrated (concentrated) salt solution;
control valve.

In accordance with the block diagram of the units of the apparatus, the initial aqueous salt solution is supplied for dehydration and concentration from the source of the aqueous salt solution to be dehydrated (concentrated) (SSD) through the heater unit (1) for pre-heating the solution by means of solar rays into the device for dehydration and concentration via the inlet branch pipe (14). The device for dehydration and concentration comprises a sealed housing (2), a blackbody bottom (3) impermeable for solutions, a barrier (4) permeable to solar rays and impermeable to gases and liquids, sealing partitions (5) forming labyrinth galleries in the device and configured for ensuring contact between the stream of solution being heated and dehydrated and moving therealong and the stream of atmospheric air being heated and saturated with water vapor moving thereabove, the air entering the device through the opening (16) for feeding the air stream. Continuous heating of the streams moving along the labyrinth galleries is carried out by solar rays penetrating into the device through the barriers permeable thereto. The time interval during which the streams remain in the device and the movement parameters (movement velocity, the dimensions and number of labyrinth galleries, final temperature of the interacting streams) are determined based on achieving set parameters of dehydration of the solution and upon reaching maximum moisture content in the air stream at the device outlet through the opening (17) for outputting the air stream from the final labyrinth gallery of the device, wherein a drop catcher in the form of a chain curtain (25) is arranged for removing the dispersed solution from the air stream. In order to intensify mass exchange between the interacting streams, the device comprises a spray circuit consisting of a discharge header (6) for providing circulation of the solution being dehydrated, the header connected via pipelines (7) to the exhaust of the circulation pump (8). In turn, pipelines (9) equipped with spraying members (10) and arranged along each of the labyrinth galleries in the center thereof adjoin the discharge header. Opposite ends of the pipelines are inserted into the header pipeline (11). A suction header (12) is arranged under the pipelines of the spraying system, the header crossing the device in its center perpendicular to the labyrinth galleries, and is connected via the pipelines (13) to the suction of the circulation pump. The spraying system arranged in such a way allows maintaining continuous mode of dispersing brine by means of the spraying members during progressive movement of the air stream and the solution to be dehydrated along the labyrinth galleries along their entire movement path, thus significantly increasing the contact area of the air with brine and solar rays, intensifying the processes of moisture evaporation and heating the solution and air. The dehydrated and concentrated salt solution is output from the device through a branch pipe (15) into the receptacle for the dehydrated (concentrated) solution (RCS). After passing through the drop catcher (25), the air stream heated and maximally saturated with water vapor in the device is directed through the output opening of the final labyrinth gallery by means of the fan unit (18-1) into the condenser refrigerator (19) for cooling and water vapor condensation. The initial (cold) natural lithium-bearing brine is fed countercurrently to the air stream being cooled into the coil (23) of the condenser refrigerator from the source of the initial natural lithium-bearing brine which, having received the heat of water vapor condensation through the coil, is heated and directed to the receptacle for the heated initial lithium-bearing brine (RHNLB) for subsequent use in selective sorption of lithium by means of granulated LiCl·2Al(OH)₃·mH₂O sorbent and for producing primary lithium concentrate. In turn, the primary lithium concentrate produced by the selective sorption is processed into the pregnant lithium concentrate in a similar manner.

The air stream cooled in the condenser refrigerator and depleted of moisture passes through the mist eliminator (20) separating from the dispersed water vapor condensate, and passes through the fan unit (18-2), returning to the device for dehydration and concentration of aqueous salt solutions. The fresh water in the form of condensate formed in the condenser refrigerator is directed to the fresh water collector (21), the water then is directed by means of the pump (22) through the spray header (24) for the condenser refrigerator coil to irrigate the coil surface in order to increase the heat transfer coefficient in the condenser refrigerator and is directed to the receptacle for fresh water (RFW). Control valves mounted on the pipelines control fresh water streams supplied for irrigating the coil and for the output thereof to the fresh water receptacle (RFW).

### EXAMPLE

A natural lithium-bearing multicomponent solution (brine) was dehydrated to obtain fresh water in a pilot apparatus built according to the block diagram. Brine composition is listed in Table 1.

TABLE 1
Composition of natural brine to be dehydrated (concentrated)

| Ion | Li⁺ | K⁺ | Ca²⁺ | Mg²⁺ | Na⁺ | Cl⁻ | SO₄²⁻ | B₄O₇²⁻ |
|---|---|---|---|---|---|---|---|---|
| Content, | 0.492 | 4.235 | 0.810 | 2.640 | 130.140 | 166.158 | 7.800 | 2.269 |
| g/dm³ | | | | | | | | |

Brine density: 1208 g/dm³, pH=6.4.

To simulate solar heating, light banks providing energy flow of 1374 W per m² were used. The total surface area of ray heating and dehydrating of the pilot device was 8.8 m². The cooling surface area of the condenser refrigerator was 0.46 m². Mode of movement of brine and air in the device for concentration (dehydration) and heating. Test results are summarized in Table 2.

TABLE 2
Experimental test results of dehydration of a natural brine
to produce fresh water based on the use of solar ray energy

| Parameter | Unit | Value |
|---|---|---|
| Volume flow rate of brine supplied for dehydration | dm³/h | 1000 |
| Brine density prior to dehydration | g/dm³ | 1208 |
| Temperature of brine supplied for dehydration | ° C. | 76 |
| Total salt content of brine prior to dehydration | wt % | 23.8 |
| Air volume flow rate at dehydration device inlet | m³/h | 44 |
| Air temperature at dehydration device inlet | ° C. | 26 |
| Air moisture content at dehydration device inlet | g/m³ | 19.3 |
| Dehydrated brine temperature at dehydration | ° C. | 78 |
| device outlet | | |
| Volume flow rate of dehydrated (concentrated) | dm³/h | 901.2 |
| brine output | | |
| Brine density after dehydration | g/dm³ | 1231 |
| Total salt content of brine after dehydration | wt % | 25.9 |
| Air temperature at dehydration device outlet | ° C. | 78 |
| Air volume flow rate at dehydration device outlet | m³/h | 51.6 |
| Air moisture content at dehydration device outlet | g/m³ | 208 |
| Temperature of brine supplied for cooling steam- | ° C. | 17 |
| air stream in condenser refrigerator | | |
| Volume flow rate of brine supplied for cooling | dm³/h | 419.3 |
| to condenser refrigerator | | |
| Brine temperature at refrigerator condenser outlet | ° C. | 32 |
| Volume flow rate of fresh water produced in the | dm³/h | 9.896 |
| form of water vapor condensate | | |
| Air stream temperature at mist eliminator outlet | ° C. | 26 |
| Air moisture content at mist eliminator outlet | g/m³ | 19.4 |

It follows from the contents of Table 2 that the practical test confirms the applicability of the claimed method and apparatus for producing fresh water from aqueous salt solutions (brines).

### References

1. U.S. Pat. No. 4,243,392, Process for solar concentration of lithium chloride brines. P. M. Brown et al.
2. U.S. Pat. No. 4,274,834, Process for purification of lithium chloride. P. M. Brown et al.
3. U.S. Pat. No. 4,271,131, Production of highly pure lithium chloride from impure brines. P. M. Brown et al.
4. PCT WO2009/131628 A1, Method of making high purity lithium hydroxide and hydrochloric acid. D. J. Buckley. Filed on Apr. 9, 2009.
5. US Patent Application Publication 2020/03056696, Method for separation and enrichment of lithium. Min Wang et al.
6. Russian Federation Patent 2516538, Method for producing lithium concentrate from lithium-bearing natural brines and for processing thereof. A. D. Ryabtsev et al. Filed on Feb. 17, 2012.
7. Russian Federation Patent 2656452, Method for producing lithium hydroxide monohydrate from brines and apparatus for implementing the method. N. M. Nemkov et al. Filed on Feb. 4, 2016.
8. Russian Federation Patent 2713360, Method for producing lithium hydroxide monohydrate from brines. A. D. Ryabtsev et al. Filed on Sep. 25, 2019.

What is claimed is:

1. A method for producing fresh water from an aqueous salt solution at a facility utilizing a natural lithium-bearing brine for producing a lithium product in the conditions of high solar activity and arid climate, the method comprising:
evaporating water upon heating a stream of aqueous salt solution to produce a stream of aqueous salt concentrate and a stream of water vapor; separating the water vapor stream from the stream of aqueous salt concentrate; and
cooling the water vapor stream with converting it into a stream of water vapor condensate being fresh water;
wherein the water vapor condensate is obtained by cooling a forcibly moved stream of atmospheric air saturated with water vapor, the air being previously heated and saturated with water vapor during its movement and straight flow contact with a forcibly moved stream of initial aqueous salt solution being heated in isolation from the environment, accompanied by maximum saturation of the atmospheric air stream with water vapor extracted from the aqueous salt solution and by concentration of the aqueous salt solution,
and wherein the produced stream of aqueous salt concentrate is removed from the process, and the stream of atmospheric air having passed the stage of water vapor cooling and condensation is again directed for contacting and joint heating with a fresh stream of initial aqueous salt solution, thus forming a closed circuit with a circulating stream of the atmospheric air and the flowing movement of the salt solution stream being concentrated.

2. The method according to claim 1, characterized in that the heating the atmospheric air stream and the aqueous salt solution stream moving in a straight flow and contacting each other in isolation from the environment is carried out by means of solar energy transmitted to the streams being heated directly by solar rays through a layer of a material permeable to the solar rays and impermeable to atmospheric air and aqueous media.

3. The method according to claim 1, characterized in that the solution stream supplied for dehydration and concentration is pre-heated by means of solar rays during transportation thereof through a heating element of a heater unit, wherein an outer surface of the heating element is painted black.

4. The method according to claim 1, characterized in that the pre-heated aqueous salt solution stream is dehydrated and concentrated in a countercurrent movement of the brine stream towards the air stream being transported.

5. The method according to claim 1, characterized in that during the movement, the solar heating, the contact with the atmospheric air stream, and the concentration, the aqueous salt solution is continuously forcibly dispersed.

6. The method according to claim 1, characterized in that the aqueous salt solution is a natural multicomponent lithium-bearing brine.

7. The method according to claim 1, characterized in that the aqueous salt solution is a mother brine formed after sorption extraction of lithium from a natural multicomponent lithium-bearing brine on granulated LiCl·2Al(OH)₃·mH₂O sorbent selective for lithium chloride.

8. The method according to claim 1, characterized in that the aqueous salt solution is a primary lithium concentrate in the form of an aqueous solution of lithium chloride with impurities in the form of brine macrocomponents, the concentrate being formed by desorption extraction of lithium chloride, using fresh water, from the lithium-saturated granulated LiCl·2Al(OH)₃·mH₂O sorbent during direct contact with a natural multicomponent lithium-bearing brine.

9. The method according to claim 1, characterized in that a natural multicomponent lithium-bearing brine is used as a coolant for cooling the heated atmospheric air saturated with water vapor.

10. The method according to claim 1, characterized in that a catholyte in the form of an aqueous solution of lithium hydroxide is used as the aqueous salt solution supplied for dehydration and concentration, the aqueous solution of lithium hydroxide being produced by means of membrane electrolysis of a pregnant lithium chloride solution obtained from a primary lithium concentrate extracted from a natural multicomponent lithium-bearing brine using granulated LiCl·2Al(OH)₃·mH₂O sorbent and fresh water.

11. An apparatus for implementing the method according to claim 1, the apparatus comprising:
a heating unit for pre-heating, by solar rays, an aqueous salt solution supplied for dehydration and concentration,
a device for dehydration by means of solar energy, the device comprising:
a sealed housing comprising a blackbody bottom impermeable to the solutions;
a barrier impermeable to gases and liquids and permeable to solar rays;
sealing partitions forming labyrinth galleries providing free movement of the aqueous salt solution being dehydrated within the device along the bottom and of air above the aqueous salt solution being dehydrated along a set path with a set path length;
a discharge header for circulating the solution, the header connected at its ends to the exhaust of the circulation pump by means of pipelines and connected by its side surface through a branch pipe to a pipeline provided with a spraying member and mounted along the labyrinth galleries in the center of each labyrinth gallery and connected by their opposite ends to a header pipeline forming a closed spray circuit;
a suction header providing circulation of the solution through the spray circuit and representing a perforated tube crossing the device along the center perpendicular to the labyrinth galleries below the level of the pipelines of the spray circuit and connected to the suction of the circulation pump at its ends by means of pipelines;
a drop catcher in the form of a chain curtain, the catcher being arranged in the labyrinth gallery which is the last along gas stream path;
a branch pipe for feeding the solution being dehydrated into the device and outputting a concentrated solution out of the device;
openings for feeding the air stream into an initial labyrinth gallery of the device for heating and saturating with water vapor and outputting the heated air stream saturated with water vapor through a final labyrinth gallery of the device;
a fan unit for circulating the air stream through the labyrinth galleries of the device; a condenser refrigerator for cooling the air stream saturated with water vapor and heating an initial natural lithium-bearing brine;
a mist eliminator for the water vapor condensate dispersed within the air stream;
a water vapor condensate collector; and
a pump for spraying the condenser refrigerator coil and outputting a produced fresh water,
a source of the aqueous salt solution being dehydrated,
a receptacle for the dehydrated salt solution,
a source of the initial natural brine, and
a receptacle for fresh water.

12. The apparatus according to claim 11, characterized in that the output opening of the final labyrinth gallery of the device for dehydration and concentration of the solution is connected with a suction branch pipe of the fan unit by means of a gas duct, wherein the fan unit is connected at its exhaust branch pipe with an inlet gas branch pipe of the condenser refrigerator by means of a gas duct, wherein the condenser refrigerator is connected at its outlet gas branch pipe to an inlet branch pipe of the mist eliminator by means of a gas duct, wherein the mist eliminator is connected at its outlet gas branch pipe to the suction branch pipe of the fan unit connected at its exhaust branch pipe to a feeding opening of the initial gallery of the device by means of a gas duct.

13. The apparatus according to claim 11, characterized in that the inlet branch pipe of the condenser refrigerator coil is connected with the source of the initial natural brine by means of a pipeline, and the outlet branch pipe of the condenser refrigerator coil is connected with a receptacle for the heated initial natural brine, wherein the spray header of the condenser refrigerator coil is connected at its ends to the outlet branch pipe of the pump for spraying the condenser refrigerator coil and outputting the produced fresh water by means of a pipeline through a control valve, wherein the pump is further connected to the receptacle for fresh water by means of a pipeline through a control valve, and the suction branch pipe of the pump is directly connected via a pipeline to the fresh water collector collecting water in the form of water vapor condensate; wherein the fresh water collector collecting water in the form of water vapor condensate is in turn connected via a pipeline to the condensate drain branch pipe of the mist eliminator.

14. The apparatus according to claim 11, characterized in that a branch pipe for feeding the aqueous salt solution being dehydrated into the device for dehydration and concentration of the aqueous salt solution is connected to a source of the solution being dehydrated and concentrated via a pipeline through a heater unit for pre-heating, by solar rays, the aqueous salt solution supplied for dehydration and concentration, and a branch pipe for outputting the concentrated salt solution from the device for dehydration and concentration of the aqueous salt solution is connected to a receptacle for the concentrated salt solution via a pipeline.

15. The method according to claim 2, characterized in that the solution stream supplied for dehydration and concentration is pre-heated by means of solar rays during transportation thereof through a heating element of a heater unit, wherein an outer surface of the heating element is painted black.

16. The method according to claim 2, characterized in that the pre-heated aqueous salt solution stream is dehydrated and concentrated in a countercurrent movement of the brine stream towards the air stream being transported.

17. The method according to claim 2, characterized in that during the movement, the solar heating, the contact with the atmospheric air stream, and the concentration, the aqueous salt solution is continuously forcibly dispersed.

18. The method according to claim 2, characterized in that the aqueous salt solution is a natural multicomponent lithium-bearing brine.

19. The method according to claim 2, characterized in that the aqueous salt solution is a mother brine formed after sorption extraction of lithium from a natural multicomponent lithium-bearing brine on granulated LiCl·2Al(OH)₃·mH₂O sorbent selective for lithium chloride.

20. The method according to claim 2, characterized in that the aqueous salt solution is a primary lithium concentrate in the form of an aqueous solution of lithium chloride with impurities in the form of brine macrocomponents, the concentrate being formed by desorption extraction of lithium chloride, using fresh water, from the lithium-saturated granulated LiCl·2Al(OH)₃·mH₂O sorbent during direct contact with a natural multicomponent lithium-bearing brine.
